(19) United States
(12) Patent Application Publication
(10) Pub. No.: US 2012/0304432 A1
(43) Pub. Date: Dec. 6, 2012

(54) MOUNTING MECHENISM FOR TOUCH SCREEN

(75) Inventors: XIN-YAN WANG, Shenzhen City (CN); GUANG-JUN QIN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/327,441

(22) Filed: Dec. 15, 2011

(30) Foreign Application Priority Data
Jun. 3, 2011 (CN) 201110149080.3

(51) Int. Cl. B25B 27/14

(52) U.S. Cl. 29/281.3

(57) ABSTRACT

A touch screen mounting mechanism for mounting a touch screen on a housing includes a base, a mounting board fixed on the base, a push element slidably mounted on the base along the vertical direction of the base, drive members fixed on the mounting board and positioning elements slidably mounted on the surface of the mounting board and located around a positioning slot. The mounting board defines a positioning slot for retaining the touch screen and the housing, the push element defines driving wedge walls, the drive members are used to drive the push element to slide, each positioning element defines a following wedge wall resisting on one driving wedge wall, and in mounting, the following wedge walls are pushed by the driving wedge walls to slide towards the center of the positioning slot to position the touch screen and the housing in the correct order.

### BACKGROUND

1. Technical Field

The disclosure generally relates to mounting mechanisms for mounting touch screens to housings.

2. Description of the Related Art

A touch type electronic device such as touch type mobile phone may include a housing and a touch screen. The housing defines a holding groove. The touch screen is held in the holding groove. The touch screen may be manually mounted in the holding groove, which may cause unnecessary gaps between the touch screen and housing.

Therefore, there is room for improvement within the art.

### BRIEF DESCRIPTION OF THE DRAWINGS

Many aspects of the exemplary mounting mechanism for a touch screen can be better understood with reference to the following drawings. The components in the various drawings are not necessarily drawn to scale, the emphasis instead being placed upon clearly illustrating the principles of the exemplary mounting mechanism for a touch screen. Moreover, in the drawings, like reference numerals designate corresponding parts throughout the diagrams.

FIG. 1 is an isometric view of a mounting mechanism for a touch screen according to an exemplary embodiment.

FIG. 2 is an exploded view of the mounting mechanism for a touch screen shown in FIG. 1.

FIG. 3 is a cross-sectional view of the mounting mechanism for a touch screen shown in FIG. 1, taken along line III-III.

FIG. 4 is a cross-sectional view of the mounting mechanism for a touch screen shown in FIG. 1, taken along line IV-IV.

FIG. 5 is an enlarged view of the area V-V shown in FIG. 4.

FIG. 6 is similar to FIG. 1, showing the mounting mechanism for a touch screen in use.

FIG. 7 is a view of a housing and a touch screen mounted by the mounting mechanism shown in FIG. 1.

### DETAILED DESCRIPTION

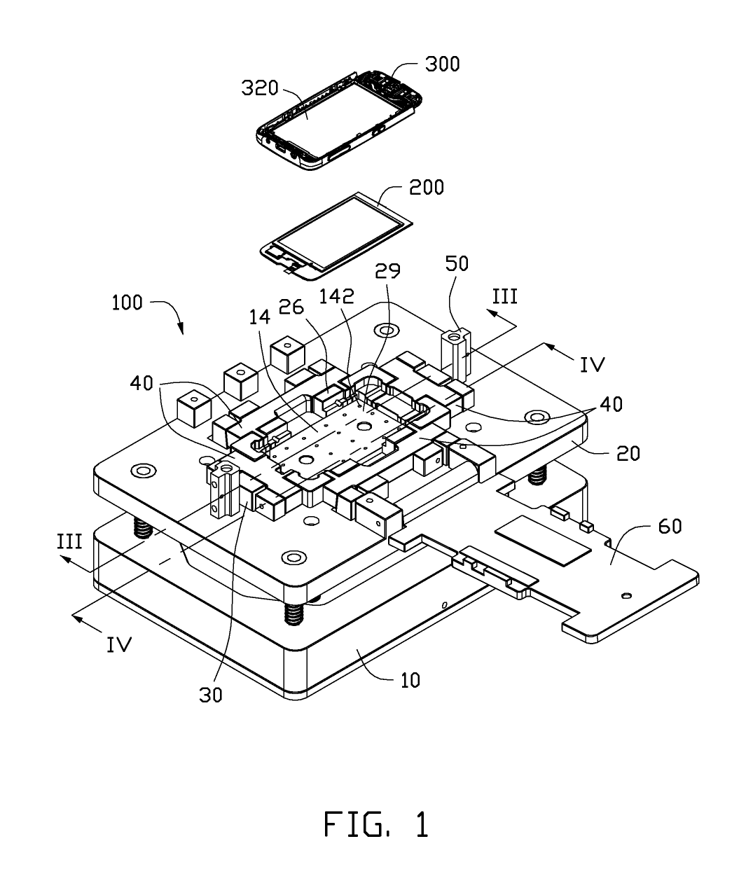

FIG. 1 shows an exemplary touch screen mounting mechanism 100 used to mount a touch screen 200 on a housing 300. The housing 300 defines a holding groove 320, and the screen 200 is held in the holding groove 320.

The touch screen mounting mechanism 100 includes a base 10, a mounting board 20, a push element 30, positioning elements 40, drive members 50 and a pressing cover 60. The mounting board 20 is fixed on the base 10. The push element 30 is slidably mounted on the base 10. The positioning elements 40 are slidably mounted on the surface of the mounting board 20. The drive members 50 are fixed on the mounting board 20 for making the push element 30 slide. The pressing cover 60 is hinged to the mounting board 20.

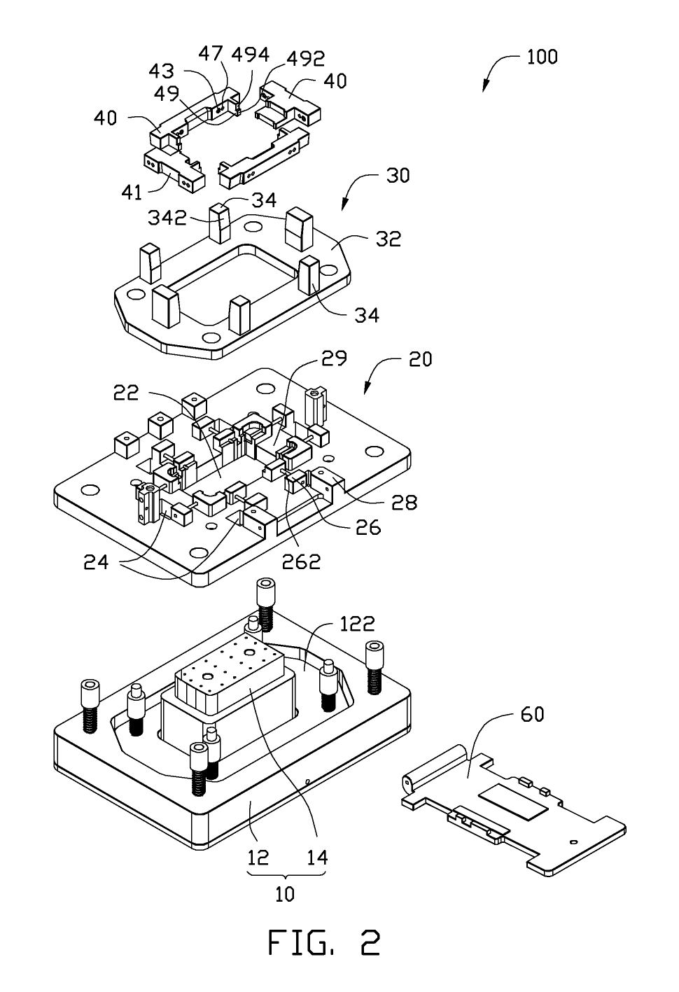

Referring to FIG. 2, the base 10 includes a bottom board 12 and a supporting stand 14 projecting from the bottom board 12. The supporting stand 14 is used to support the screen 200 and the housing 300. The supporting stand 14 defines a number of vacuum holes 142 for providing a vacuum to facilitate the attaching of the screen 200 onto the supporting stand 14. The bottom board 12 defines a mounting groove 122 between the stand 14 and the bottom board 12.

The mounting board 20 defines a first hole 22 and a number of second holes 24 located around the first hole 22. The supporting stand 14 is retained in the first hole 22. The surface of the mounting board 20 furthest from the base 10 has limiting portions 26 and two opposite protruding hinging portions 28 projecting therefrom. The limiting portions 26 cooperatively define a positioning slot 29. Each limiting portion 26 has a guiding pin 262 fixed thereon. The guiding pins 262 are used to guide the positioning elements 40 to slide along the mounting board 20. The hinging portions 28 are used to hinge the pressing cover 60 onto the mounting board 20.

The push element 30 includes a base board 32 and pushing pillars 34 projecting from the base board 32. Each pushing pillar 34 is retained in a corresponding second hole 24. The end of each pushing pillar 34 defines a driving wedge wall 342.

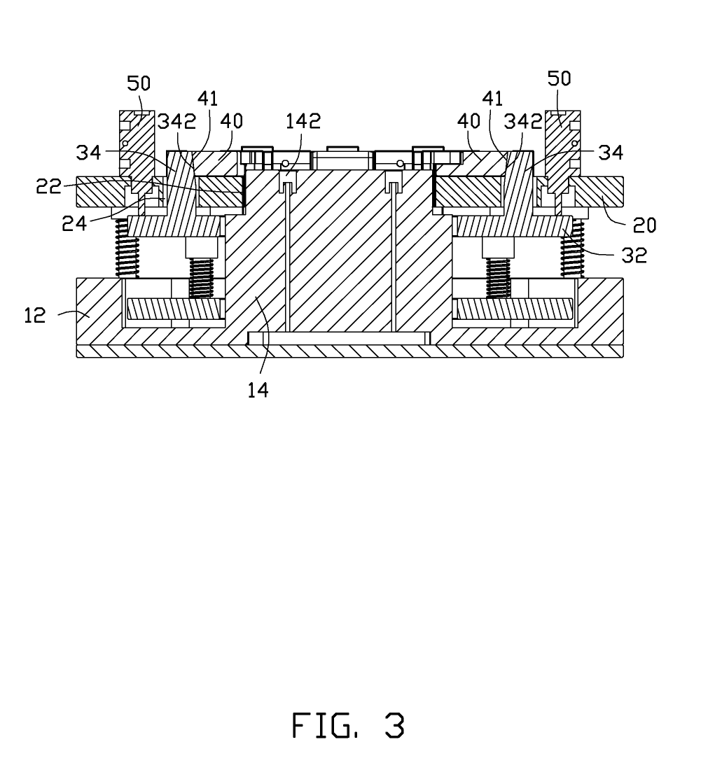

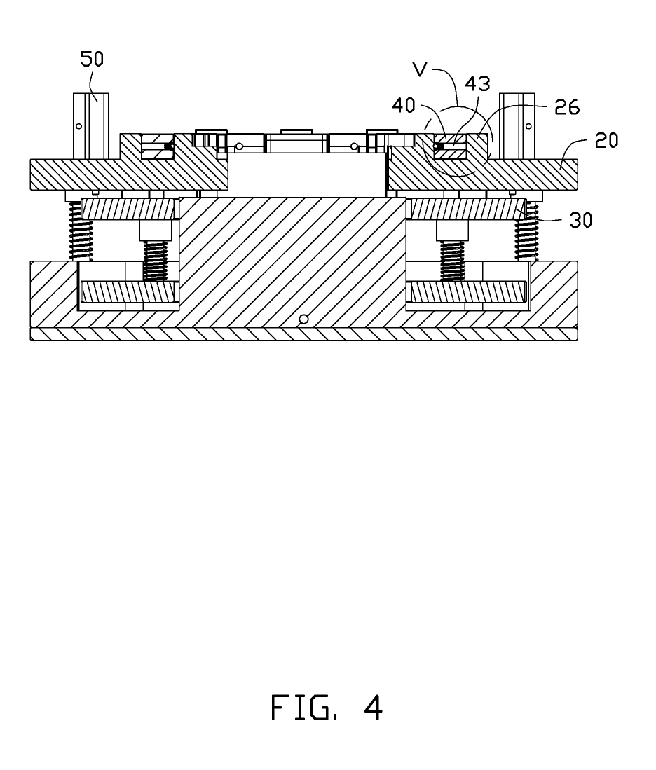

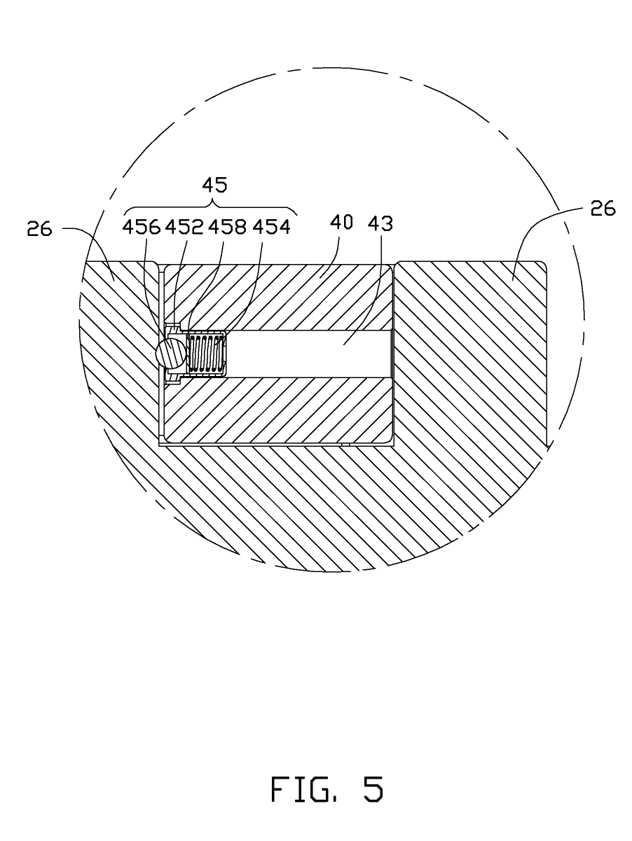

Referring to FIGS. 3-5, the positioning elements 40 are mounted on the mounting board 20 around the first hole 22. Each positioning element 40 is latched between at least one limiting portion 26 and at least one pushing pillar 34. Each positioning element 40 includes a following wedge wall 41, a repositioning hole 43, a repositioning module 45, a guiding hole 47 and a positioning step 49.

A driving wedge wall 342 resists against each following wedge wall 41, and the push element 30 can push the portioning element 40 to slide towards the first hole 22 on the mounting board 20. The repositioning hole 43 is located near the limiting portion 26, and the repositioning module 45 is retained in the repositioning hole 43.

The repositioning module 45 includes a limiting cover 452 mounted in the repositioning hole 43, a spring 454 retained in the limiting cover 452, a resisting ball 456 partially extending from the cover 452 and a supporting board 458 clamped between the spring 454 and the resisting ball 456. One end of the spring 454 rests against the supporting board 458, the opposite end rests against the cover 452. When there is no external force pressing on the ball 456, the spring 454 is slightly compressed, leaving the ball 456 partially extended from the cover 452, but not outside it.

Each guiding hole 47 is used to receive a guiding pin 262. The guiding pins 262 are slidably mounted in the guiding holes 47 to enable the positioning element 40 to slide along the mounting board 20. Each positioning step 49 includes a first step surface 492 for clamping the screen 200 and a second step surface 494 for clamping the housing 300. The first step surface 492 is nearer than the second step surface 494 to the supporting stand 14.

In assembling the touch screen mounting mechanism 100, the base board 32 of the push element 30 is fixed into the mounting groove 122. The mounting board 20 is mounted onto the push element 30 until each pushing pillar 34 is retained in a second hole 24. The positioning elements 40 are slidably mounted on the mounting board 20 via the guiding pins 262. At this time, each following wedge wall 41 of the positioning elements 40 butts against a driving wedge wall 342, and the push element 30 can push the portioning element 40 to slide towards the first hole 22 on the mounting board 20. Then the pressing cover 60 is hinged on the hinging portions 28 of the mounting board 20.

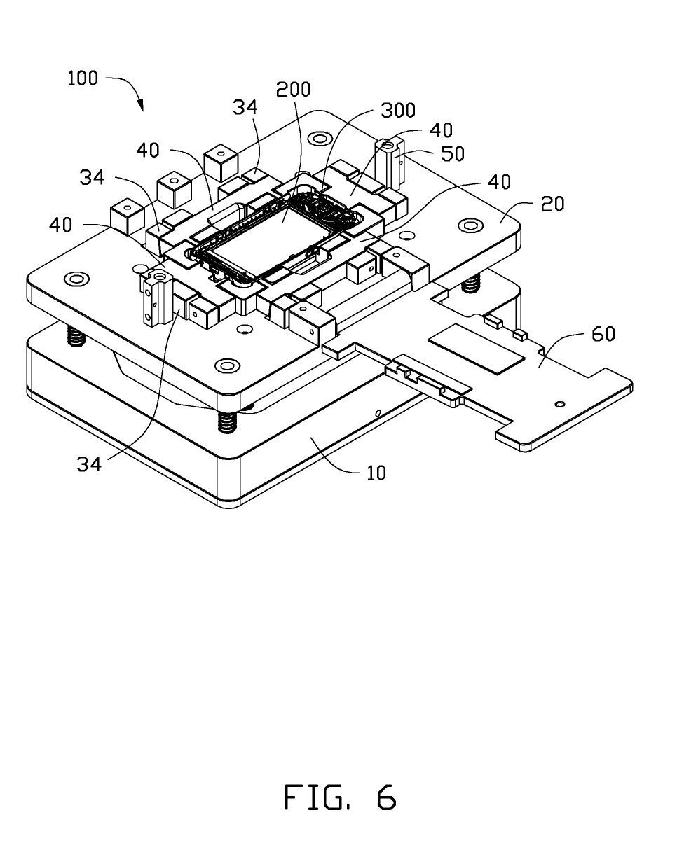

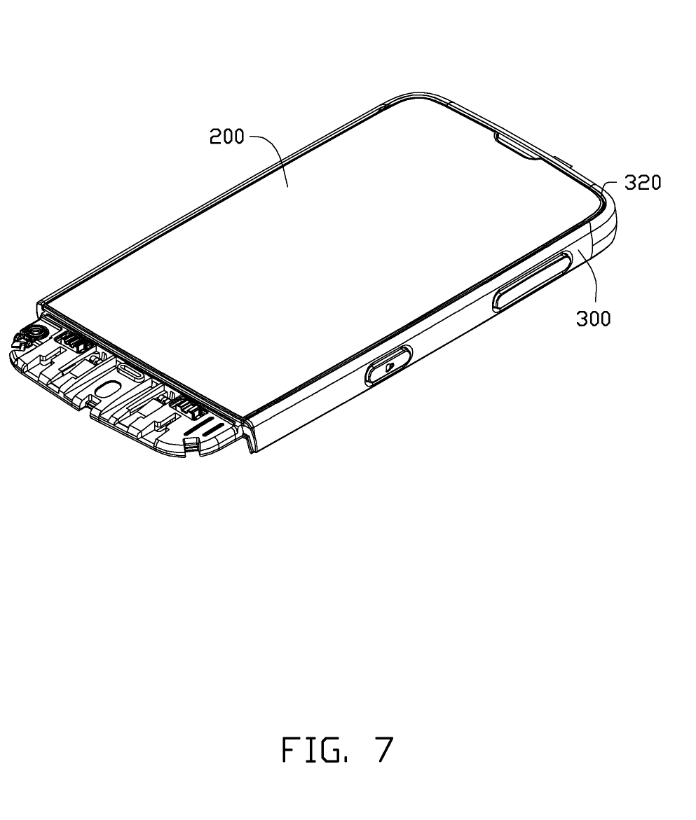

Referring to FIGS. 6 and 7, in use, the screen 200 is placed into the positioning slot 29. The screen 200 is located on the vacuum holes 142. At this time, the mechanism 100 has not been moved or manipulated. The push element 30 is located nearest to the bottom board 12, and the driving wedge wall 342 is resisting against the following wedge wall 41.

By triggering the drive members 50, the drive members 50 drive the pushing pillars 34 of the push element 30 to slide towards the mounting board 20. The pushing pillars 34 further push the positioning element 40 to slide towards the screen 200. When the positioning element 40 slides, the ball 456 is pushed back by the limiting portion 26, and the spring 454 is further compressed by the ball 456 to store an elastic force. When the peripheral wall of the screen 200 is clamped by the first step surface 492 of the positioning element 40, the supporting stand 14 holds the screen 200 by virtue of the vacuum existing in the vacuum holes 142. When the drive members 50 are triggered again, the drive members 50 drive the push element 30 to restore. The stored elastic force is released and the driving wedge wall 342 is driven to resist against the following wedge wall 41 during the second triggering of the drive members 50.

The housing 300 is placed into the positioning slot 29, and the screen 200 is located in the holding groove 320 of the housing 300. The drive members 50 are pressed a third time, and the drive members 50 make the positioning element 40 slide towards the housing 300 until the peripheral wall of the housing 300 is clamped by the second step surface 494 of the positioning element 40. Before the step of placing the screen 200 and the housing 300 into the positioning slot 29, adhesive is spread on the surface of the screen 200 opposite to the holding groove 320. The pressing cover 60 is rotated to press onto the housing 300 to fix the screen 200 into the holding groove 320. The pressing cover 60 is rotated away from the housing 300, the screen 200 and the housing 300 are moved away from the positioning slot 29 together after the vacuum is removed. The screen 200 is then mounted on the housing 300.

In using the touch screen mounting mechanism 100, the screen 200 is positioned by the first step surface 492, and then the peripheral wall of the housing 300 is positioned by the second step surface 494. Accordingly, any gap existing between the screen 200 and the peripheral wall of the holding groove 320 of the housing 300 have a uniform size.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A touch screen mounting mechanism for mounting a touch screen to a housing, comprising:
abase;
a mounting board fixed on the base, and defining a positioning slot for retaining the touch screen and the housing;
a push element slidably mounted on the base, the push element defining driving wedge walls;
drive members fixed on the mounting board for making the push element slide; and
positioning elements slidably mounted on the mounting board and located around the positioning slot, each positioning element defining a following wedge wall resisted against corresponding one driving wedge wall;
wherein the positioning elements is driven towards the center of the positioning slot and configured to position the touch screen and the housing in order under the resisting action between the following wedge walls and the driving wedge walls.

2. The touch screen mounting mechanism as claimed in claim 1, wherein each positioning element comprises a positioning step, the positioning step comprises a first step surface for clamping the touch screen and a second step surface for clamping the housing, and the first step surface is nearer than the second step surface to the supporting stand.

3. The touch screen mounting mechanism as claimed in claim 1, wherein the base comprises a bottom board and a supporting stand projected from the bottom board, the mounting board defines a first hole retaining the supporting stand.

4. The touch screen mounting mechanism as claimed in claim 3, wherein the supporting stand defines vacuum holes for providing vacuum to facilitate the attaching of the touch screen onto the supporting stand.

5. The touch screen mounting mechanism as claimed in claim 1, wherein the push element comprises a base board and pushing pillars projected from the base board, each pillar defines one driving wedge wall.

6. The touch screen mounting mechanism as claimed in claim 5, wherein the mounting board defines second holes around the positioning slot, each pillar is slidably mounted in corresponding one second hole.

7. The touch screen mounting mechanism as claimed in claim 1, wherein the mounting board has limiting portions projecting from the surface of the mounting board, the limiting portions are located around the positioning slot.

8. The touch screen mounting mechanism as claimed in claim 7, wherein each limiting portion has a guiding pin fixed, each positioning element defines a guiding hole, the each guiding pin is retained in corresponding one guiding hole to guide the positioning elements to slide on the mounting board.

9. The touch screen mounting mechanism as claimed in claim 1, wherein each positioning element defines a repositioning hole, the positioning element further comprises a repositioning modules, each repositioning module is retained in one repositioning hole.

10. The touch screen mounting mechanism as claimed in claim 9, wherein each repositioning module comprises a limiting cover mounted in the each repositioning hole, a spring retained in the limiting cover, a resisting ball partially extended from the cover and a supporting board clamped between the spring and the resisting ball, one end of the spring is resisted on the supporting board, the opposite end is resisted against the limiting cover.

11. The touch screen mounting mechanism as claimed in claim 1, wherein the touch screen mounting mechanism further comprises a pressing cover, the pressing cover is hinged on the mounting board for pressing the housing on the touch screen.
